(19) United States
(12) Patent Application Publication
(10) Pub. No.: US 2005/0025948 A1
(43) Pub. Date: Feb. 3, 2005

(54) Composite laminate reinforced with curvilinear 3-D fiber and method of making the same

(76) Inventors: David W. Johnson, San Diego, CA (US); James M. Hook, Alpine, CA (US); Scott A. Garrett, San Diego, CA (US); Stephen G. Moyers, Jamul, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/931,167

(22) Filed: Aug. 31, 2004

Related U.S. Application Data
(63) Continuation-in-part of application No. 10/744,630, filed on Dec. 23, 2003.
Application No. 10/744,630 is a continuation of application No. 10/059,956, filed on Nov. 19, 2001, now Pat. No. 6,676,785.
(60) Provisional application No. 60/298,523, filed on Jun. 15, 2001.
(60) Provisional application No. 60/281,838, filed on Apr. 6, 2001.
(60) Provisional application No. 60/293,939, filed on May 29, 2001.

(51) Int. Cl. B32B 3/00

(52) U.S. Cl. 428/223; 264/136; 264/137

(57) ABSTRACT

A composite laminate structure includes a first face sheet having a plurality of ply layers; a second face sheet having a plurality of ply layers; and a plurality of groupings of 3-D fibers extending from the first skin to the second skin, and integrated into the plurality of ply layers of the first face sheet and the second face sheet in at least a Z-X direction.

### REFERENCE TO RELATED APPLICATION

This application is a continuation-in-part of U.S. patent application Ser. No. 10/744,630 filed Dec. 23, 2003, which is a continuation of U.S. patent application Ser. No. 10/059,956, U.S. Pat. No. 6,676,785, filed Nov. 19, 2001, which claims the benefit of provisional patent application 60/298,523 filed on Jun. 15, 2001; provisional patent application 60/281,838 filed on Apr. 6, 2001; and provisional patent application 60/293,939 filed on May 29, 2001 under 35 U.S.C. 119(e).

### TECHNICAL FIELD

The present invention relates to an improvement in the field of composite laminate structures known as sandwich structures formed with outside skins of a polymer matrix composite and an internal core, and more specifically to the field of these sandwich structures which additionally have some type of Z-axis fiber reinforcement through the composite laminate and normal to the plane of the polymer matrix composite skins.

### BACKGROUND ART

There is extensive use in the transportation industry of composite laminate structures due to their lightweight and attractive performance. These industries include aerospace, marine, rail, and land-based vehicular. The composite laminate structures are made primarily from skins of a polymer matrix fiber composite, where the matrix is either a thermoset or thermoplastic resin and the fiber is formed from groupings of fiber filaments of glass, carbon, aramid, or the like. The core is formed from end-grain balsa wood, honeycomb of metallic foil or aramid paper, or of a wide variety of urethane, PVC, or phenolic foams, or the like.

Typical failures in laminate structure can result from core failure under compressive forces or in shear or, most commonly, from a failure of the bond or adhesive capability between the core and the composite skins (also known as face sheets). Other failures, depending on loading may include crimpling of one or both skins, bending failure of the laminate structure, or failure of the edge attachment means from which certain loads are transferred to the laminate structure.

Certain patents have been granted for an art of introducing reinforcements that are normal to the planes of the skins, or at angles to the normal (perpendicular) direction. This is sometimes called the “Z” direction as it is common to refer to the coordinates of the laminate skins as falling in a plane that includes the X and Y coordinates. Thus the X and Y coordinates are sometimes referred to as two-dimensional composite or 2-D composite. This is especially appropriate as the skins are many times made up of fiber fabrics that are stitched or woven and each one is laid on top of each other forming plies or layers of a composite in a 2-D fashion. Once cured these 2-D layers are 2-D laminates and when failure occurs in this cured composite, the layers typically fail and this is known as interlaminar failure.

The patents that have been granted that introduce reinforcements that are normal to the X and Y plane, or in the generally Z-direction, are said to be introducing reinforcements in the third dimension or are 3-D reinforcements. The purpose of the 3-D reinforcement is to improve the physical performance of the sandwich structure by their presence, generally improving all of the failure mechanisms outlined earlier, and some by a wide margin. For example, we have shown that the compressive strength of a foam core laminate structure with glass and vinyl ester cured skins can be as low as 30 psi. By adding 16 3-D reinforcements per square inch, that compressive strength can exceed 2500 psi. This is an 83 times improvement.

Childress in U.S. Pat. No. 5,935,680, Boyce et al in U.S. Pat. No. 5,741,574 as well as Boyce et al in U.S. Pat. No. 5,624,622 describe Z-directional reinforcements that are deposited in foam by an initial process and then secondarily placed between plies of fiber fabric and through heat and pressure, the foam crushes or partially crushes forcing the reinforcements into the skin. Practically, these reinforcements are pins or rods and require a certain stiffness to be forced into the skin or face layers. Although Boyce et al describes “tow members” as the Z-directional reinforcement, practically, these are cured tow members, or partially cured tow members that have stiffness. As Boyce et al describes in U.S. Pat. No. 5,624,622, compressing the foam core will “drive” the tow members into the face sheets. This cannot be possible unless the Z-directional or 3-D reinforcements are cured composite or metallic pins.

A standard roll of fiberglass roving from Owens Corning, typically comes in various yields (of yards per pound weight) and a yield of 113 would contain on a roll or doft 40 lbs. of 113 yield rovings. In the uncured state, these rovings are multiple filaments of glass fiber, each with a diameter of less than 0.0005 inches. The roving, uncured as it comes from Owens Corning, is sometimes called a “tow”contains hundreds of these extremely small diameter filaments. These hundreds of filaments shall be referred to as a “grouping of fiber filaments.” These groupings of fiber filaments can sometimes be referred to, by those skilled in the art, as tows. It is impossible to drive a virgin glass fiber tow, or grouping of fiber filaments, as it is shipped from a glass manufacturer such as Owens Corning, through a face sheet. The grouping of fiber filaments will bend and kink and not be driven from the foam carrier into the skin or face sheets as described by Boyce et al. Therefore, the “tow” described by Boyce et al must be a rigid pin or rod in order for the process to work as described.

It will be shown that the present invention allows easily for the deposition of these groupings of fiber filaments, completely through the skin-core-skin laminate structure, a new improvement in this field of 3-D reinforced laminate structures.

This issue is further verified by an earlier patent of Boyce et al, U.S. Pat. No. 4,808,461, in which the following statement is made: “The material of the reinforcing elements preferably has sufficient rigidity to penetrate the composite structure without buckling and may be an elemental material such as aluminum, boron, graphite, titanium, or tungsten.” This particular referenced patent depends upon the core being a “thermally decomposable material”. Other US Patents that are included herein by reference are: Boyce et al, U.S. Pat. No. 5,186,776; Boyce et al U.S. Pat. No. 5,667,859; Campbell et al U.S. Pat. No. 5,827,383; Campbell et al U.S. Pat. No. 5,789,061; Fusco et al U.S. Pat. No. 5,589,051.

None of the referenced patents indicate that the referenced processes can be automatic and synchronous with pultrusion, nor do they state that the processes could be synchronous and in-line with pultrusion. Day describes in U.S. Pat. Nos. 5,589,243 and 5,834,082 a process to make a combination foam and uncured glass fabric core that is later molded. The glass fiber in the core never penetrates the skins of the laminate and instead fillets are suggested at the interface of the interior fiber fabric and the skins to create a larger resin fillet. This is a poor way to attempt to tie the core to the skins, as the fillet will be significantly weaker than if the interior fiber penetrated the skins. Day has the same problem that Boyce et al have as discussed earlier. That is, the interior uncured fabric in Day's patent is limp and cannot be “driven” into the skins or face sheets without being rigid. Thus the only way to take preinstalled reinforcements in foam, and then later mold these to face sheets under pressure, and further have the interior fiber forced into the skins, is to have rigid reinforcements, such as rigid pins or rods or, as in Day's case, rigid sheets.

Boyce et al in U.S. Pat. No. 5,186,776 depends on ultrasound to insert a fiber through a solid laminate that is not a sandwich structure. This would only be possible with a thermoplastic composite that is already cured and certain weaknesses develop from remelting a thermoplastic matrix after the first solidification. Ultrasound is not a requirement of the instant invention as new and improved means for depositing groups of fiber filaments are disclosed. U.S. Pat. No. 5,869,165 describes “barbed” 3-D reinforcements to help prevent pullout. The instant invention has superior performance in that the 3-D groups of fiber filaments are extended beyond the skins on both sides of the composite laminate, such that a riveting, or clinching, of the ends of the filaments occurs when the ends of the filaments are entered into the pultrusion die and cured “on-the-fly.” The clinching provides improved pull-out performance, much in the same way as a metallic rivet in sheet metal, that is clinched or bent over on the ends, improves the “pull-out” of that rivet versus a pin or a bonded pin in sheet metal. This is different from the current state-of-the-art. Fiber through the core is either terminated at the skins, unable to penetrate the skins, or as pure rods penetrates part or all of the skin, but is not riveted or clinched. And many of the techniques referenced will not work with cores that don't crush like foam. For example, the instant invention will also work with a core such as balsa wood, which will not crush and thus cannot “drive” cured rods or pins into a skin or face sheet. Furthermore, the difficult, transition from a composite laminate structure to an edge can easily be accommodated with the instant invention. As will be shown later, a composite laminate structure can be pultruded with clinched 3-D groupings of fiber filaments and at the same time the edges of the pultruded composite laminate can consist of solid composite with the same type and quantity of 3-D grouping of fiber filaments penetrating the entire skin-central composite-skin interface. As will be shown, the skins can remain continuous and the interior foam can transition to solid composite laminate without interrupting the pultrusion process.

It is an object of this invention to provide a low cost alternative to the current approaches such that the composite laminate structure can find its way into many transportation applications that are cost sensitive. All prior art processes referenced have a degree of manual labor involved and have been only successful to date where aerospace is willing to pay the costs for this manual labor. The instant invention is fully automatic and thus will have extremely low selling prices. For example, earlier it was mentioned that by adding a certain number of groups of fiber filaments to a foam core composite laminate that the compressive strength improved from 30 psi to over 2500 psi. This can be achieved for only $0.30 per square foot cost. None of the existing processing techniques referenced can compare to that performance-to-cost ratio. This can be achieved due the automated method of forming the composite laminate structure. Other differences and improvements will become apparent as further descriptions of the instant invention are given.

### SUMMARY OF INVENTION

The method and apparatus for forming an improved pultruded and clinched Z-axis fiber reinforced composite structure starts with a plurality of upper and lower spools that supply raw material fibers that are formed respectively into upper and lower skins that are fed into a primary wet-out station within a resin tank. A core material is fed into the primary wet-out station between the respective upper and lower skins to form a composite laminate preform. The upper and lower skins and the core are pulled automatically through tooling where the skin material is wetted-out with resin and the entire composite laminate is preformed in nearly its final thickness. The composite laminate preform continues to be pulled into an automatic 3-dimensional Z-axis fiber deposition machine that deposits “groupings of fiber filaments” at multiple locations normal to the plane of the composite laminate structure and cuts individual groups such that an extension of each “grouping of fiber filaments” remains above the upper skin and below the lower skin.

The preformed composite laminate then continues to be pulled into a secondary wet-out station. Next the preformed composite laminate is pulled through a pultrusion die where the extended “groupings of fiber filaments” are all bent over above the top skin and below the bottom skin producing a superior clinched Z-axis fiber reinforcement as the composite laminate continues to be pulled, catalyzed and cured at a back section of the pultrusion die. The composite laminate continues to be pulled by grippers that then feed it into a gantry CNC machine that is synchronous with the pull speed of the grippers and where computerized machining, drilling and cutting operations take place. The entire process is accomplished automatically without the need for human operators.

It is an object of the invention to provide a novel improved composite laminate structure that has riveted or clinched 3-D groupings of fiber filaments as part of the structure to provide improved resistance to delaminating of the skins or delaminating of the skins to core structure.

It is also an object of the invention to provide a novel method of forming the composite laminate structure wherein an automatic synchronous pultrusion process is utilized, having raw material, for example glass fabric such as woven roving or stitched glass along with resin and core material pulled in at the front of a pultrusion line and then an automatic deposition station places 3-D Z-axis groupings of fiber filaments through a nearly net-shape sandwich preform and intentionally leaves these groupings longer than the thickness of the sandwich structure, with an extra egress. This is then followed by an additional wet-out station to compliment an earlier wet-out station. The preform then is pulled into a pultrusion die and is cured on the fly and the 3-D Z-axis groupings of fiber filaments are riveted, or clinched, in the die to provide a superior reinforcement over the prior art. The cured composite laminate structure is then fed into a traveling CNC work center where final fabrication machining operations, milling, drilling, and cut-off occur. This entire operation is achieved with no human intervention.

It is another object of the invention to utilize core materials that do not require dissolving or crushing as previous prior art methods require.

It is a further an object of the invention to provide a novel pultruded panel that can be continuous in length, capable of 100 feet in length or more and with widths as great as 12 feet or more.

It is an additional object of the invention to produce a 3-D Z-axis reinforced composite laminate structure wherein the edges are solid 3-D composite to allow forming of an attachment shape or the machining of a connection.

It is another object of the invention to provide a preferred embodiment of a temporary runway, taxiway, or ramp for military aircraft. This composite laminate structure would replace current heavier aluminum structure, (known as matting) and could easily be deployed and assembled. The 3-D Z-axis reinforcements ensure the panels can withstand the full weight of aircraft tire loads, yet be light enough for easy handling.

A further object of the invention is to provide a composite laminate structure including a first face sheet having a plurality of ply layers; a second face sheet having a plurality of ply layers; and a plurality of groupings of 3-D fibers extending from the first face sheet to the second face sheet, and integrated into the plurality of ply layers of the first face sheet and the second face sheet in at least a Z-X direction.

A still further object of the invention is to provide method of making a composite laminate structure including the steps of providing a wetted-out composite laminate structure preform impregnated with a resin, the preform including a first face sheet having a plurality of ply layers, a second face sheet having a plurality of ply layers, and a plurality of groupings of Z-axis fibers being generally perpendicular to the first skin and the second skin and extending from the first skin to the second skin; providing a pultrusion die for pultruding the wetted-out composite laminate structure; pultruding the wetted-out composite laminate structure with the pultrusion die so that the wetted-out composite laminate structure compresses in thickness and the plurality of groupings of Z-axis fibers are integrated into the plurality of ply layers of the first face sheet and the second face sheet in at least a Z-X direction; and co-curing the wetted-out composite laminate structure so as to produce a co-cured composite laminate structure where at least the plurality of Z-axis groupings of fibers, the first face sheet and the second face sheet are primary bonded, and the plurality of groupings of Z-axis fibers are integrated into the plurality of ply layers of the first face sheet and the second face sheet in at least a Z-X direction.

### DESCRIPTION OF THE DRAWINGS

FIG. 1 is a schematic illustration of a method and apparatus for forming continuously and automatically the subject 3-D Z-axis reinforced composite laminate structure;

FIG. 2 is schematic vertical cross sectional view of a pultruded composite laminate panel in a preferred embodiment, in which the clinched 3-D Z-axis fibers have been cured on the fly, showing side details. This panel would be used as a new lightweight matting surface for temporary military aircraft runway use;

FIG. 3 is a magnified view taken along lines 3-3 of FIG. 2;

FIG. 4 is a magnified view taken along lines 4-4 of FIG. 3.

FIG. 5 is a schematic vertical cross-sectional view of the pultruded sandwich panel of the preferred embodiment, just prior to entering the pultrusion die, wherein the 3D Z-axis groupings of fiber filaments have been deposited and they are prepared for clinching and riveting in the die;

FIG. 6 is a magnified view taken along lines 6-6 of FIG. 5;

FIG. 7 is a magnified view taken along lines 7-7 of FIG. 6; and

FIG. 8 is a magnified view taken along lines 8-8 of FIG. 2.

FIG. 9 is a cross-sectional view of an embodiment of a 3-D Z-axis reinforced composite laminate structure prior to resin impregnation.

FIG. 10 is a cross-sectional view of an embodiment of a co-cured composite laminate structure reinforced with curvilinear 3-D fiber bundles.

FIG. 11 is a cross-sectional view of the 3-D Z-axis reinforced composite laminate structure of FIG. 10 after resin impregnation.

FIG. 12 is an enlarged cross-sectional view of the 3-D Z-axis reinforced composite laminate structure of FIG. 11 taken in section 12-12 of FIG. 11.

FIG. 13 is a perspective view of an embodiment of a pultrusion die that may be used to perform the exemplary pultrusion process described herein.

FIG. 14 is a cross-sectional view of an embodiment of a die entrance of the pultrusion die illustrated in FIG. 13 and shows an embodiment of a wetted-out preform panel of the 3-D Z-axis reinforced composite laminate structure as it is pulled into the pultrusion die.

FIG. 15 is an enlarged cross-sectional view, similar to FIG. 12, of the 3-D Z-axis reinforced composite laminate structure as it is pulled into the pultrusion die.

FIG. 16 is a cross-sectional view of an embodiment of a die exit of the pultrusion die illustrated in FIG. 13 and shows an embodiment of a co-cured composite laminate panel reinforced with curvilinear fiber bundles as it is pulled out of the pultrusion die.

FIG. 17 is a cross-sectional view of another embodiment of a co-cured composite laminate structure reinforced with curvilinear 3-D fiber bundles.

FIG. 18 is a cross-sectional view, similar to FIG. 14, of the die entrance of the pultrusion die illustrated in FIG. 13 and shows an alternative exemplary process where one or more additional layers are added to the face sheet material of a wetted-out preform panel of the 3-D Z-axis reinforced composite laminate structure as it is pulled into the pultrusion die.

### DESCRIPTION OF PREFERRED EMBODIMENT

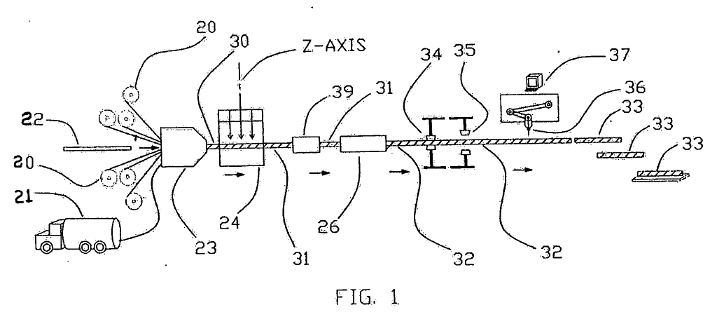

FIG. 1 illustrates a method and application for forming a pultruded and clinched 3-D Z-axis fiber reinforced composite laminate structure. The pultrusion direction is from left-to-right in FIG. 1 as shown by the arrows. The key components of the apparatus will become evident through the following description.

Shown in FIG. 1 are the grippers 34 and 35. These are typically hydraulically actuated devices that can grip a completely cured composite laminate panel 32 as it exits pultrusion die 26. These grippers 34, 35 operate in a hand-over-hand method. When gripper 34 is clamped to the panel 32, it moves a programmed speed in the direction of the pultrusion, pulling the cured panel 32 from the die 26. Gripper 35 waits until the gripper 34 has completed its full stroke and then takes over.

Upstream of these grippers, the raw materials are pulled into the die in the following manner. It should be recognized that all of the raw material is virgin material as it arrives from various manufacturers at the far left of FIG. 1. The fiber 20 can be glass fiber, either in roving rolls with continuous strand mat or it can be fabric such as x-y stitched fabric or woven roving. Besides glass, it can be carbon or aramid or other reinforcing fiber. A core material 22 is fed into the initial forming of the sandwich preform. The skins of the sandwich will be formed from the layers of fiber 20 on both the top and bottom of the sandwich preform 30. The core 22 will be the central section of the sandwich. The core can be made of urethane or PVC foam, or other similar foams in densities from 2 lbs. per cubic foot to higher densities approaching 12 lbs. per cubic foot. Alternatively core 22 could be made of end-grain balsa wood having the properties of 6 lb. per cubic foot density to 16 lb. per cubic foot.

The raw materials are directed, automatically, in the process to a guidance system in which resin from a commercial source 21 is directed to a primary wet-out station within resin tank 23. The wetted out preform 30 exits the resin tank and its debulking station in a debulked condition, such that the thickness of the panel section 30 is very nearly the final thickness of the ultimate composite laminate. These panels can be any thickness from 0.25 inches to 4 inches, or more. The panels can be any width from 4 inches wide to 144 inches wide, or more. Preform 30 is then directed to the Z-axis fiber deposition machine 24 that provides the deposition of 3-D Z-axis groupings of fiber filaments. The details as to how Z-axis filter deposition machine 24 functions is the subject of the referenced provisional patent application 60/293,939 and U.S. patent application Ser. No. 09/922,053 filed Aug. 2, 2001 is incorporated into this patent application by reference. This system is computer controlled so that a wide variety of insertions can be made. Machine 24 can operate while stationary or can move synchronously with the gripper 34 speed. Groupings of fiber filaments are installed automatically by this machine into the preform 31 that is then pulled from the Z-axis fiber deposition machine 24. Preform 31 has been changed from the preform 30 by only the deposition of 3-D Z-axis groupings of fiber filaments, all of which are virgin filaments as they have arrived from the manufacturer, such as Owens Coming.

Modified preform 31 of FIG. 1 now automatically enters a secondary wet-out station 39. Station 39 can be the primary wet-out, eliminating station 23, as an alternative method. This station helps in the completion of the full resin wet-out of the composite laminate structure, including the 3-D Z-axis groupings of fiber filaments. Preform 31 then enters pultrusion die 26 mentioned earlier and through heat preform 31 is brought up in temperature sufficiently to cause catalyzation of the composite laminate panel. Exiting die 26 is the final cured panel section 32 which is now structurally strong enough to be gripped by the grippers 34 and 35.

The sandwich structure of FIG. 1 can then be made any length practicable by handling and shipping requirements. Downstream of the grippers 34 and 35, the preform 32 is actually being “pushed” into the downstream milling machine system, 36 and 37. Here a multi-axis CNC machine (computer numerical control) moves on a gantry synchronous with the gripper pull speed, and can machine details into the composite laminate structure/panel on the fly. These can be boltholes, edge routing, milling, or cut-off. The machine 36 is the multi-axis head controlled by the computer 37. After cut-off, the part 33 is removed for assembly or palletizing and shipping.

FIG. 2 illustrates a vertical cross-section of one preferred embodiment. It is a cross-section of a panel 40 that is 1.5 inches thick and 48 inches wide and it will be used as a temporary runway, taxiway, or ramp for military aircraft. In remote locations, airfields must be erected quickly and be lightweight for transporting by air and handling. Panel 40 of FIG. 2 achieves these goals. Because it has been reinforced with the Z-axis groupings of fiber filaments, the panel can withstand the weight of aircraft tires, as well as heavy machinery. Since panel 40 is lightweight, at approximately 3 lbs. per square foot, it achieves a goal for the military, in terms of transportation and handling. Because 40 is pultruded automatically by the process illustrated in FIG. 1, it can be produced at an affordable price for the military. Also shown in FIG. 2 are edge connections, 41 and 42. These are identical but reversed. These allow the runway panels 40 also known as matting, to be connected and locked in place. Clearly, other applications for these composite structures exist beyond this one embodiment.

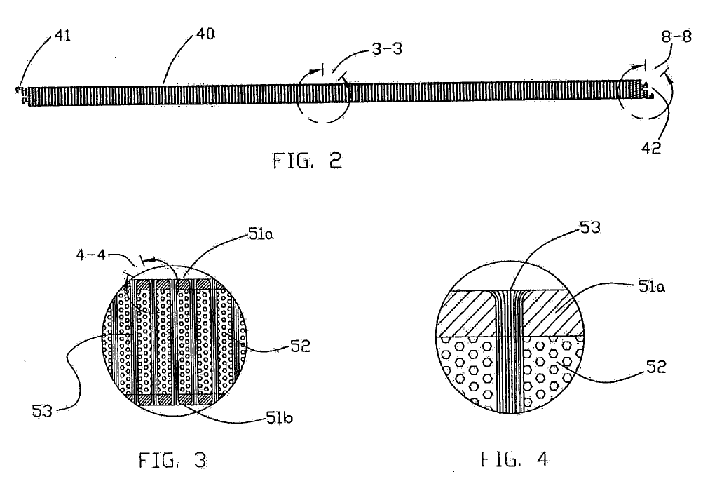

FIG. 3 is a magnified view taken along lines 3-3 of FIG. 2. FIG. 3 shows the cross section of the composite laminate structure, including the upper and lower skins 51a and 51b. respectfully. Core 52, which is shown as foam, clearly could be other core material such as end-grain balsa wood. Also shown are the several 3-D Z-axis groupings of fiber filaments 53, which are spaced in this embodiment every 0.25 inches apart and are approximately 0.080 inches in diameter. It can be seen from FIG. 3 that the groupings of fiber filaments 53 are clinched, or riveted to the outside of the skins, 51a and 51b. FIG. 4 is a magnified view taken along lines 4-4 of FIG. 3. FIG. 4 shows core material 52 and the upper skin section 51a and lower skin section 51b. These skin sections are approximately 0.125 inches thick in this embodiment and consists of 6 layers of X-Y stitched glass material at 24 oz. per square yard weight. The Z-axis groupings of fiber filaments 53 can be clearly seen in FIG. 4. The clinching or riveting of these filaments, which lock the skin and core together, can clearly be seen.

FIGS. 2, 3, and 4 show the runway matting material as it would be produced in the method and apparatus of FIG. 1. The schematic section 40 in FIG. 2 is fully cured as it would be leaving pultrusion die 26. Similar drawings of these same sections are shown for the preform of the runway matting material as it would look just prior to entering pultrusion die 26 by FIGS. 5, 6, and 7. FIGS. 5, 6 and 7 correlate with the preform 31 of FIG. 1. FIGS. 2, 3, and 4 correlate with the preform 32 and the part 33 of FIG. 1.

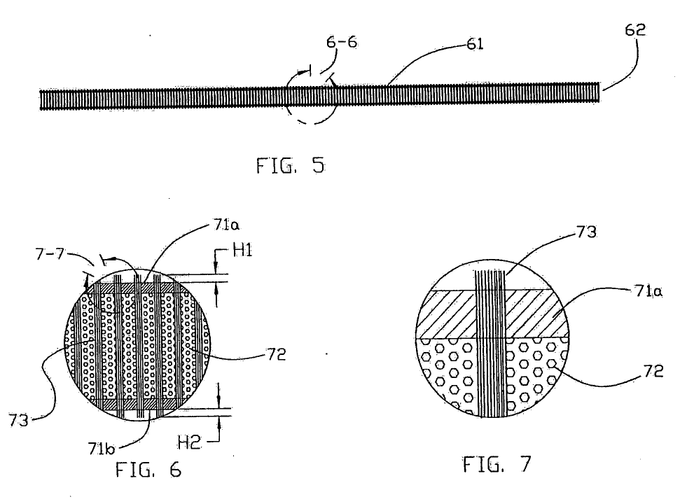

FIG. 5 schematically illustrates the entire matting panel 61 as a preform. The end of the panel 62 does not show the details 42, of FIG. 2 for clarity. The lines 6-6 indicate a magnified section that is shown in FIG. 6.

FIG. 6 shows the skins 71a and 71b, the core 72 and the 3-D groupings of Z-axis fiber filaments 73. One can see the egressing of the fiber filaments above and below skins 71a and 71b by a distance H1 and H2, respectively. The lines 7-7 indicate a further magnification which is illustrated in FIG. 7.

FIG. 7 shows the preform with the core 72 and upper skin material 71a and a single group of Z-axis fiber filaments 73. Note the egressed position of the fiber filaments, which after entering the pultrusion die will be bent over and riveted, or clinched, to the composite skin. Because the skins 71a and 71b are made of X-Y material and the grouping of fiber filaments are in the normal direction to X-Y, or the Z-direction, the composite skin in the region of the 3-D grouping of fiber filaments is said to be a three dimensional composite.

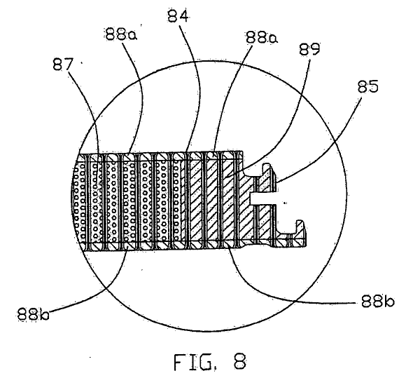

FIG. 8 is a magnified view taken along lines 8-8 of FIG. 2 and schematically depicts a core material 87, a skin material 88a and 88b and a new interior composite material 89. As stated this material 89 would consist of X-Y fiber material that is the same as the skin material 88a and 88b but is narrow in width, say 2 to 3 inches wide in this matting embodiment. The 3-D groupings of Z-axis fiber filaments 84 are deposited by the Z-axis deposition machine 24 in FIG. 1, and are operated independent of the density of the material. The 3-D groupings of fiber Z-axis filaments can be easily deposited through either the core material 87 or the higher density X-Y material 89. The interlocking connecting joint 85 can be either machined into the shape of 85 in FIG. 8 or can be pultruded and shaped by the pultrusion die. In FIG. 8 joint 85 is machined. If it were pultruded, the 3-D groupings of Z-axis fiber filaments in 85 would show riveted or clinched ends. Clearly other interlocking joints or overlaps could be used to connect matting panels.

With reference to FIGS. 9-18, a composite laminate reinforced with curvilinear fiber and a method of making the same will be described.

FIG. 9 illustrates a series of discrete bundles of 3-D fibers 100 deposited in a sandwich structure 110, which may include face sheet material, face sheet, or skin material 120 on outsides of the sandwich structure 110 and an interior core material 130, prior to resin impregnation and catalyzation. The 3-D fiber bundles 100 may be deposited in the same manner as the fiber bundles 73 described above. The 3-D fiber bundles 100 illustrated in FIG. 9 are “virgin” fiber in that the fiber bundles 100 have not been exposed to resin, and, therefore have no significant stiffness or rigidity. In the prior art, cured or rigid pins have been used to deposit 3-D reinforcement into a composite sandwich; however, the bonds later formed in the cured composite sandwich have secondary bonds with the rigid 3-D pins. These secondary bonds form relatively weak joints.

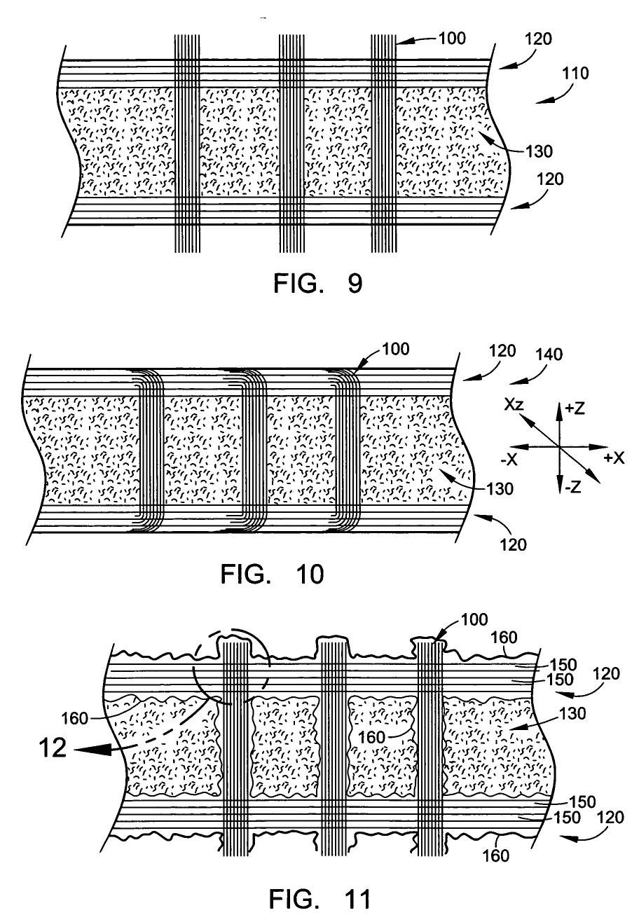

In accordance with an embodiment of the invention, FIG. 10 illustrates a cured composite laminate 140 reinforced with curvilinear fiber bundles 100. The fiber bundles 100 are co-cured with the X-Y fibrous layers of the face sheet material 120 so that primary bonds occur between the 3-D fiber bundles 100 and the X-Y fibrous layers of the face sheet material 120. These primary bonds make the 3-D fiber-reinforced composite laminate 140 significantly stronger than the 3-D pin-reinforced composite laminates of the prior art. The curvilinear nature of the fiber bundles 100 in the face sheet material 120 also provides structural advantages in the composite laminate 140 that will be discussed in more detail farther below.

FIG. 11 shows the 3-D fiber bundles 100 in the sandwich structure 110 prior to processing. Within the face sheet material 120 are individual ply layers 150. FIG. 11 also shows resin 160 that has impregnated the sandwich structure 110 and fiber bundles 100. Resin 160 migrates bi-directionally, in both directions, along the length of the fiber bundles 100 through capillary action to impregnate the fiber bundles 100 and the sections of the ply layers 150.

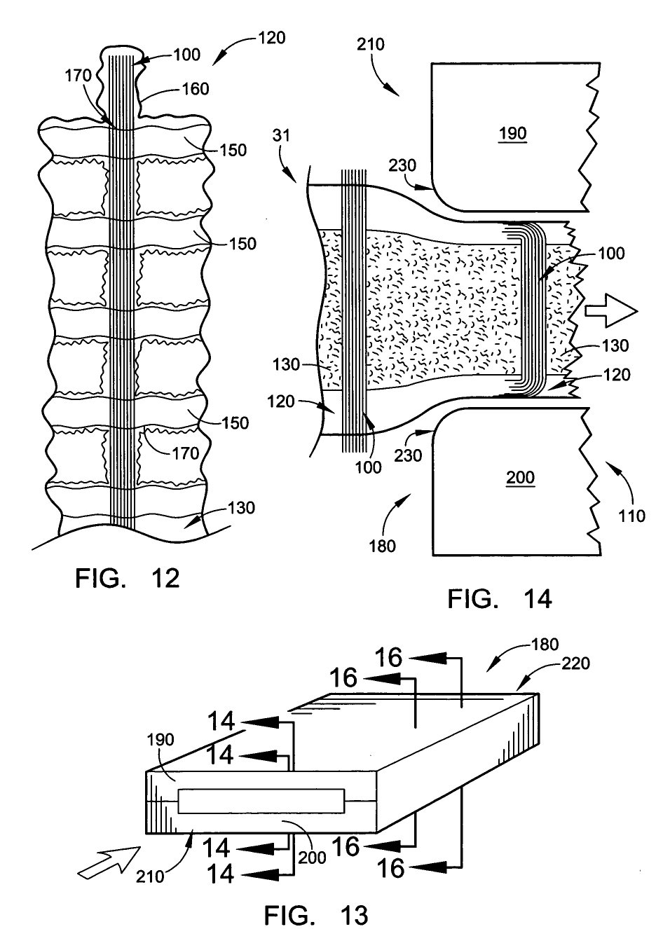

FIG. 12 shows an enlarged cross-sectional view of the multiple ply layers or X-Y material layers 150 in the upper face sheet material 120 with one of the 3-D fiber bundles 100 extending from the interior core material 130 to a distance above the upper face sheet material 120. The multiple ply layers 150 and the 3-D fiber bundle 100 is shown impregnated with the resin 160. Although the ply layers 150 are shown separated by a space filled with resin 160, it should be noted that in reality no space may exist or the space may be very small because the layers 150 may be in contact with each other or the layers 150 may be separated by a very thin layer of resin 160. The 3-D fiber bundle 100 is not rigid and is generally straight through all of the ply layers 150 in the Z direction prior to co-curing and after the 3-D fiber bundle insertion process. After the 3-D fiber bundle 100 has been inserted through the interior core material 130 and the ply layers 150, each ply layer 150 closes around the perimeter of the 3-D fiber bundle 100. This creates an intimate contact point or area 170 between the perimeter of the 3-D fiber bundle 100 and its intersection with each ply layer 150 due to the spring characteristics of the ply layers 150. These contact points or areas 170 occur everywhere the 3-D fiber bundles 100 intersect with each ply layer 150.

With reference to FIGS. 13-16, the pultrusion process for creating a composite laminate 140 reinforced with curvilinear fiber 100 (cured, co-cured, and primary-bond-cured sandwich structure) as shown in FIG. 10 from the wetted-out, uncured, sandwich structure 110 of FIGS. 11, 12 will now be described.

FIG. 13 shows a perspective view of an embodiment of a pultrusion die 180 used to create the composite laminate 140 and co-cured, clinched curvilinear fibers 100 shown in FIG. 10. The die 180 includes a top die member 190, a bottom die member 200, a die entrance 210, and a die exit 220. The preform 31 enters the die entrance 210 in the direction of the arrow shown.

FIG. 14 shows the process occurring at the die entrance 210. The wetted-out preform 31 is pulled into the pultrusion die 180 by the grippers 34, 35 in the direction of the arrow shown. The top die member 190 and the bottom die member 200 each include a curved edge or standard inlet radius 230 at the die entrance 210 to facilitate the pultrusion process. Each radius 230 facilitates the clinching process described above and causes the 3-D fiber bundles 100 to take on a curvilinear shape in the ply layers 150 of the upper and lower face sheet materials 120.

The distance between the top die member 190 and the bottom die member 200 is less than the thickness of the preform 31. As a result, as the preform 31 is pulled into the pultrusion die 180, the sandwich structure 110 is compressed. For example, a 3.100 inch, wetted-out preform 31 may be compressed to 3.000 inches within the pultrusion die 180. This compression assists with squeeze-out of excess resin and with forming the 3-D fiber bundle 100 into the curvilinear shape.

It should be noted that in the condition shown in FIG. 14, the curvilinear 3-D fiber bundle 100 and the face sheet material 120 are not cured. The co-curing and primary bonding may occur approximately one-half to two-thirds of the way through the die 180, depending on factors such as, but not limited to, line speed, temperature zones, and resin chemistry.

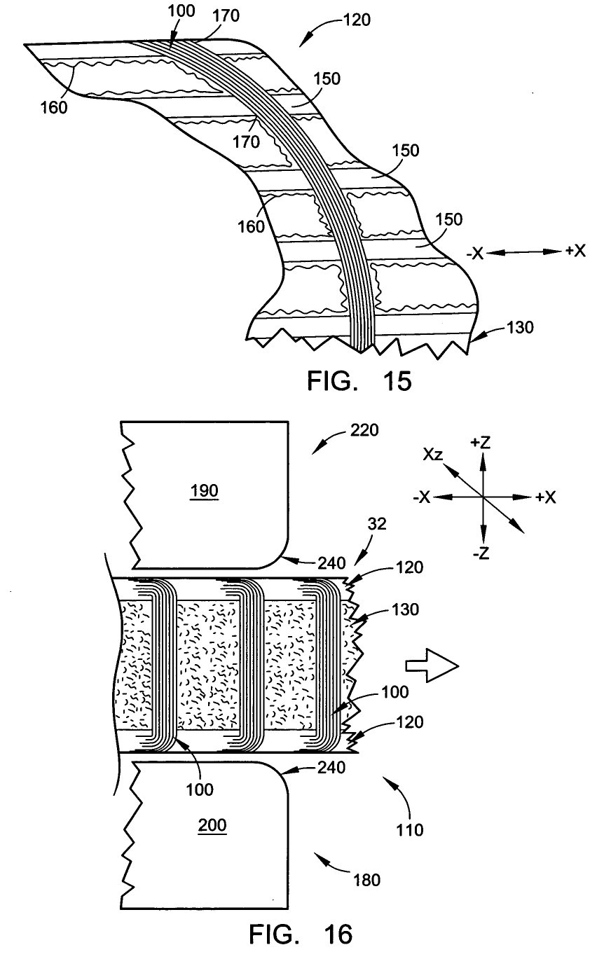

With reference to FIG. 15, a more detailed explanation of the changes that occur with the 3-D fiber bundles 100 and the sandwich structure 110 as the wetted-out preform 31 is pulled into the pultrusion die 180 will be described. As the sandwich structure 110 is pulled into the pultrusion die 180, the ply layers 150 slip with respect to each other in the X direction because the bulk of the fibers in each 3-D fiber bundle 100 resist being bent at right angles (bending of the fibers at right angles would cause the fibers to fracture); frictional forces in the pultrusion die 180 allow the outermost ply layers 150 (those layers 150 closest to the die 180) to slip in the X-direction as the 3-D fiber bundle 100 is gradually changed to a curvilinear shape; the wetted-out ply layers 150 easily slip relative to each other, due to low friction between ply layers 150 caused by fully wetted out resin 160 in between each ply layer 150; and the clinching of multiple numbers of 3-D fiber bundles 100 into the face sheet material 120 provides a significant X-directional force over the entire width of the sandwich panel being processed. There is a progressive movement of the ply layers 150 in the X direction that progressively increases from the innermost ply layers 150 to the outermost ply layers 150. Because of the nature of the intimate contact points or areas 170, the 3-D fiber bundle 100 is formed into the curvilinear path shown in FIG. 15.

The curvilinear shape of the 3-D fiber bundle 100 taken on in the ply layers 150 of the face sheet materials 120 as the wetted-out preform 31 is pulled into the pultrusion die 180 causes the 3-D fiber bundle 100 to be pulled in opposite directions where the 3-D fiber bundle 100 enters the ply layers 150 on the top and bottom of the interior core material 130, placing the 3-D fiber material in tension. Placing the 3-D fiber bundle 100 in tension prior to co-curing causes the 3-D fiber bundle 100 to be maintained in a generally straight condition in the interior core material 130 prior to and during co-curing. This maximizes the strength properties of the composite material.

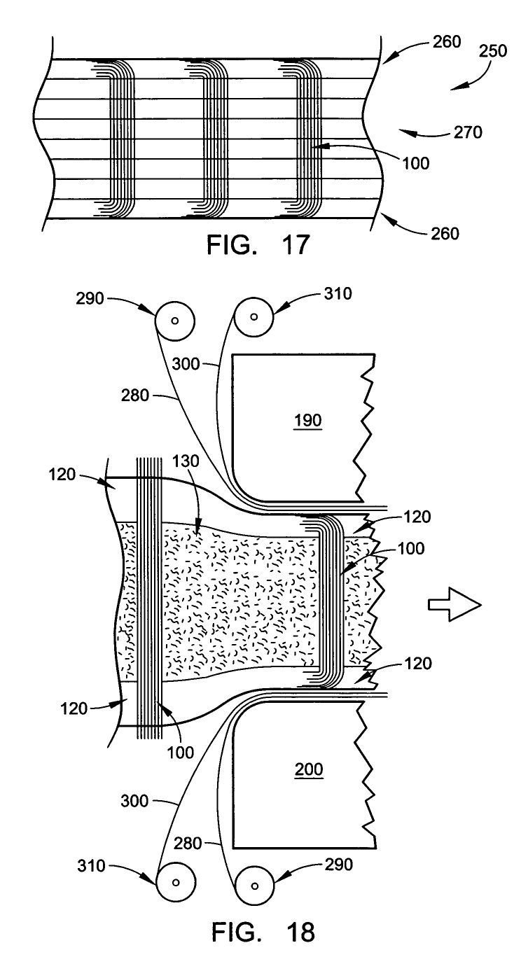

FIG. 16 shows the process occurring at the die exit 220 after curing. A section of a sandwich structure 110 of a completely cured composite laminate panel 140 reinforced with curvilinear fiber bundles 100 is shown exiting the die exit 220 in the direction of the arrow shown. The top die member 190 and the bottom die member 200 of the die exit 220 each include a curved edge or outlet radius 240 that is advantageous to the smooth exit of the cured composite laminate panel 140 from the pultrusion die 180. Because the sandwich structure 110 is completely cured, the sandwich structure 110 does not expand beyond the distance between the top die member 190 and the bottom die member 200 when exiting the pultrusion die 180.

The sandwich structure 110 exiting the pultrusion die 180 has 3-D fiber bundles that are discrete and are generally Z-directional through the core material 130, are Z-X directional through the face sheet material 120, and are X-directional in the outermost layer of the face sheet material 120, being clinched and fully integrated into this outermost layer.

With reference to FIG. 10, the completely cured composite laminate panel 140 reinforced with curvilinear fiber bundles 100 has a primary bond between all 3-D fiber bundles 100 and face sheet material 120. The primary bond is a result of co-curing and is the highest order of bonding in composites, all fibers having received resin matrix material at the same time and having been cured at the same time. An examination of the skin properties of the composite laminate panel 140 illustrates the above.

The skin from a completely cured composite laminate panel 140 was separated from the rest of the panel and was tested in compression and tension in the X-direction and the Y-direction. The face sheet material was “balanced” in that is had the same quantity of 3-D fiber bundles 100 in the X-direction and the Y-direction. If the 3-D fiber bundles 100 were only Z-directional, they would not add to the tensile or compressive properties of the skin. If, however, the 3-D fiber bundle were Z, Z-X, and X directional as described above for the cured composite laminate panel 140, the tensile and compressive properties of the skin would be greater in the X-direction than the Y-direction. The tensile and compressive properties measured for 4 different face sheet material samples are shown below in Tables 1 and 2, respectively. In Samples 1 and 2, Ultimate Tensile Stress and Ultimate Compression Stress measurements were taken only in the X Direction. In Samples 3 and 4, Ultimate Tensile Stress and Ultimate Compression Stress measurements were taken only in the Y Direction.

TABLE 1

| Ultimate Tensile Stress | X-Direction | Y-Direction |
|---|---|---|
| Sample 1 | 41,293 psi | |
| Sample 2 | 44,482 psi | |
| Sample 3 | | 35,023 psi |
| Sample 4 | | 37,639 psi |

TABLE 2

| Ultimate Tensile Stress | X-Direction | Y-Direction |
|---|---|---|
| Sample 1 | 35,960 psi | |
| Sample 2 | 33,948 psi | |
| Sample 3 | | 20,403 psi |
| Sample 4 | | 23,009 psi |

It is important to note that the measured compressive stress was generally lower than the measured tensile stress for the samples. However, as evidenced by Tables 1 and 2, clearly the addition of the Z-X and X-directional reinforcement added to the strength properties in the X-direction. If not for the curvilinear fiber bundles 100 in the Z-X and X directions, the X and Y properties would have been approximately the same. This shows that the 3-D fiber bundles 100 are fully integrated and co-cured with the face sheet materials 120.

A multitude of 3-D fiber bundles 100 may be inserted into a sandwich panel over a very large area. For example, the applicants have produced a pultruded sandwich panel that is 2.0 inches thick, 38 inches wide, and 50 feet long. With 0.25 inch spacing, this results in 2,304 3-D fiber bundles 100 per square foot. Each fiber bundle 100 is formed in the same manner. As a result, each of the 2,304 3-D fiber bundles 100 adds to the strength of the X direction of the face sheet materials 120. The Z-directional characteristics of the 3-D fiber bundles 100 through the interior core material 130 adds considerably to the Z-direction properties, among other properties, of the entire sandwich structure. The difference in compressive strengths of the sandwich structure in the Z-direction can increase from 30 psi to 2,500 psi. Thus, the 3-D fiber bundles, being curvilinear components of the solid composite structure add to the Z-directional, Z-X directional, and Z-directional properties of the finished structure.

FIG. 17 illustrates a cured composite laminate 250 reinforced with curvilinear fiber bundles 100 similar to the cured composite laminate 250 described above with respect to FIGS. 9-16, except the interior core material 130 is replaced by additional ply layers 150. The layers 150 may be the same or one or more of the layers 150 may be different. The cured composite laminate 250 may also be referred to as a composite laminate that is 3-dimentional and solid. The 3-D fiber bundles 100 are curvilinear in outer layers 260 and are generally straight in the Z-direction through a central section of layers 270 of the solid composite. Thus, progressing from the central section outwards, transition of the 3-D fiber bundles 100 occurs from a Z-direction to a Z-X direction and then to a X-direction in the solid composite laminate.

FIG. 18 shows an alternative process of pultrusion that is the same as that described above with respect to FIGS. 13-16, except that one or more additional layers may be added onto the face sheet material 120 for the pultrusion process. In the embodiment shown, reinforcement material layer 280 from reinforcement material rolls 290 may be added on the face sheet material 120 as the wetted-out preform 31 is pulled into the pultrusion die 180 in the direction of the arrow shown. The reinforcement material layer 280 may be reinforcements of continuous strand mat (“CSM”) or the like added to the final pultrusion to give a very even, aesthetic, appearance to the final pultruded surface finish as well as adding X-directional, Y-directional, and X-Y directional properties to the face sheet material 120. Because the 3-D fiber bundles 100 are slightly underneath the reinforcement material layer 280 as it is being formed in the pultrusion die 180 and because random swirling may occur in the reinforcement material layer 280, the discrete ends of some of the 3-D fiber bundles 100 may intermingle with the reinforcement material layer 280 while the discrete ends of other 3-D fiber bundles 100 become fully integrated into the outermost layer of the face sheet material 120. Thus, the 3-D fiber bundles may become part of the face sheet material 110 and part of the reinforcement material layer 280 so that the X-directional component from the 3-D fiber bundles 100 may be partially integrated with the reinforcement material layer 280 and the outermost layers of face sheet material 110.

Similarly, a veil material layer 300 from veil material rolls 310 may be added on the reinforcement material layer 280 as the wetted-out preform 31 is pulled into the pultrusion die 180. The veil material layer 300 may be made of a polyester veil material generally used to protect the cured composite laminate 140 from UV rays and to provide a final aesthetic surface to the pultruded profile. Example types of polyester veil material that maybe used are sold under the brand names Remay and Nexus.

It should be noted, similar to that with the pultrusion process of FIG. 14, there is a compression of the preform 31 as it enters the pultrusion die 180. This aids consolidation and helps squeeze excess resin, which generally drips off the die entrance 210. Because of this, there is generally enough excess resin carried into the pultrusion die 180 to fully wet out the additional materials layers 280, 300.

It will be readily apparent to those skilled in the art that still further changes and modifications in the actual concepts described herein can readily be made without departing from the spirit and scope of the invention as defined by the following claims.

1. A composite laminate structure, comprising:
a first face sheet having a plurality of ply layers;
a second face sheet having a plurality of ply layers; and
a plurality of groupings of 3-D fibers extending from the first skin to the second skin, and integrated into the plurality of ply layers of the first face sheet and the second face sheet in at least a Z-X direction.

2. The composite laminate structure of claim 1, wherein the groupings of 3-D fibers are generally perpendicular to the first face sheet and the second face sheet between the first face sheet and the second face sheet.

3. The composite laminate structure of claim 2, wherein the composite laminate includes an interior core material between the first face sheet and the second face sheet.

4. The composite laminate structure of claim 2, wherein the composite laminate includes a plurality of ply layers between the first face sheet and the second face sheet.

5. The composite laminate structure of claim 1, wherein the first skin and the second skin include inner ply layers and outer ply layers, and the groupings of 3-D fibers extend more in the X direction in the outer ply layers than in the inner ply layers.

6. The composite laminate structure of claim 1, further including a reinforcement material layer and a veil material layer on both the first face sheet and the second face sheet.

7. The composite laminate structure of claim 1, wherein the first skin and the second skin are at least one of X-Y material, X-Y stitched fabric, woven roving, glass fibers, carbon fibers, and aramid fibers.

8. The composite laminate structure of claim 1, wherein the composite laminate includes an interior core material between the first face sheet and the second face sheet, and the core material is at least one of balsa wood, urethane foam, PVC foam, and phenolic foam.

9. The composite laminate structure of claim 1, wherein the composite laminate includes an interior core material between the first face sheet and the second face sheet, and the core material has a density in the range of 2 lbs. per cubic foot to 16 lbs. per cubic foot.

10. The composite laminate structure of claim 1, wherein the 3-D fibers are co-cured and primary bonded with the ply layers.

11. A method of making a composite laminate structure, comprising:
providing a wetted-out composite laminate structure preform impregnated with a resin, the preform including a first face sheet having a plurality of ply layers, a second face sheet having a plurality of ply layers, and a plurality of groupings of Z-axis fibers being generally perpendicular to the first skin and the second skin and extending from the first skin to the second skin;
providing a pultrusion die for pultruding the wetted-out composite laminate structure;
pultruding the wetted-out composite laminate structure with the pultrusion die so that the wetted-out composite laminate structure compresses in thickness and the plurality of groupings of Z-axis fibers are integrated into the plurality of ply layers of the first face sheet and the second face sheet in at least a Z-X direction;
co-curing the wetted-out composite laminate structure so as to produce a co-cured composite laminate structure where at least the plurality of Z-axis groupings of fibers, the first face sheet and the second face sheet are primary bonded, and the plurality of groupings of Z-axis fibers are integrated into the plurality of ply layers of the first face sheet and the second face sheet in at least a Z-X direction.

12. The method of claim 11, wherein during the pultruding step, the groupings of 3-D fibers are placed in tension so that they are generally perpendicular to the first face sheet and the second face sheet between the first face sheet and the second face sheet.

13. The method of claim 12, wherein the co-cured composite laminate includes an interior core material between the first face sheet and the second face sheet.

14. The method of claim 12, wherein the cu-cured composite laminate includes a plurality of ply layers between the first face sheet and the second face sheet.

15. The method of claim 11, wherein the first skin and the second skin of the co-cured composite laminate include inner ply layers and outer ply layers, and the groupings of 3-D fibers extend more in the X direction in the outer ply layers than in the inner ply layers.

16. The method of claim 11, further including the step of adding a reinforcement material layer and a veil material layer on both the first face sheet and the second face sheet prior to pultruding.

17. The method of claim 11, wherein the first skin and the second skin are at least one of X-Y material, X-Y stitched fabric, woven roving, glass fibers, carbon fibers, and aramid fibers .

18. The method of claim 11, wherein the co-cured composite laminate includes an interior core material between the first face sheet and the second face sheet, and the core material is at least one of balsa wood, urethane foam, PVC foam, and phenolic foam.

19. The method of claim 11, wherein the co-cured composite laminate includes an interior core material between the first face sheet and the second face sheet, and the core material has a density in the range of 2 lbs. per cubic foot to 16 lbs. per cubic foot.
